(19) United States
(12) Patent Application Publication
(10) Pub. No.: US 2007/0235344 A1
(43) Pub. Date: Oct. 11, 2007

(54) Process for high copper removal rate with good planarization and surface finish

(75) Inventors: Renhe Jia, Berkeley, CA (US); You Wang, Cupertino, CA (US); Gerald John Alonzo, Los Gatos, CA (US); Yongqi Hu, San Jose, CA (US); Zhihong Wang, Santa Clara, CA (US); Jie Diao, San Jose, CA (US); Stan D Tsai, Fremont, CA (US); Alpay Yilmaz, San Jose, CA (US); Lakshmanan Karuppiah, San Jose, CA (US); Liang-Yuh Chen, Foster City, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/399,560

(22) Filed: Apr. 6, 2006

(51) Int. Cl. B23H 5/08

(52) U.S. Cl. 205/663

(57) ABSTRACT

A method for electrochemical mechanical polishing (ECMP) is disclosed. The polishing rate and surface finish of the layer on the wafer are improved by controlling the surface speed of both the platen and head, controlling the current applied to the pad, and preselecting the density of the perforations on the fully conductive polishing pad. ECMP produces much higher removal rates, good surface finishes, and good planarization efficiency at a lower down force. Generally, increasing the surface speed of both the platen and the head will increase the surface smoothness. Also, increasing the current density on the wafer will increase the surface smoothness. There is virtually no difference in the smoothness of the wafer surface between the center, middle, and edge of the wafer. For copper, removal rates of 10,000 Å/min and greater can be achieved.

### BACKGROUND OF THE INVENTION

1. Field of the Invention

Embodiments of the present invention generally relate to a method for electrochemical mechanical polishing a substrate at a high removal rate and good planarization using a fully conductive polishing pad.

2. Description of the Related Art

Sub-quarter micron multi-level metallization is one of the key technologies for the next generation of ultra large-scale integration (ULSI). The multilevel interconnects that lie at the heart of this technology require planarization of interconnect features formed in high aspect ratio apertures, including contacts, vias, lines and other features. Reliable formation of these interconnect features is very important to the success of ULSI and to the continued effort to increase circuit density and quality on individual substrates and die.

As layers of materials are sequentially deposited and removed, the uppermost surface of the substrate may become non-planar across its surface and require planarization. Planarizing a surface, or “polishing” a surface, is a process where material is removed from the surface of the substrate to form a generally even, planar surface. Planarization is useful in removing undesired surface topography and surface defects, such as agglomerated materials, crystal lattice damage, and contaminated layers or materials. Planarization is also useful in forming features on a substrate by removing excess deposited material used to fill the features and to provide an even surface for subsequent levels of metallization and processing.

Higher removal rate, good planarization, and smoother surface finishes has been the goal of metal chemical mechanical polishing (CMP) for years, especially for copper CMP. Electrochemical mechanical polishing (ECMP) is a process that provides a way to achieve the goals by using a reduced down-force on the wafer so that fewer defects occur.

ECMP is used to remove conductive materials from a substrate surface by electrochemical dissolution while concurrently polishing the substrate with reduced mechanical abrasion compared to conventional CMP processes. The electrochemical dissolution is performed by applying a bias between a cathode and a substrate surface to remove conductive materials from the substrate surface into a surrounding electrolyte. Typically, the bias is applied to the substrate surface by a conductive polishing pad by which the substrate is processed. A mechanical component of the polishing process is performed by providing relative motion between the substrate and the conductive polishing pad which enhances the removal of the conductive material from the substrate.

During the ECMP process, conductive elements disposed in the conductive pad must maintain contact with the conductive layer of the substrate in order to achieve good processing results. If the conductive elements intermittently contact the conductive layer, the power source providing an electrical bias through the conductive elements may damage the wafer. Biasing the conductive elements using electrolyte flow may result in excessive quantities of electrolyte being utilized in order to achieve a desired bias force.

In the past, a ball-contact module has been used in ECMP to make the electrical contact between the power supply and the wafer surface. Now, a fully conductive polishing pad can be used for the same purpose, and the fully conductive pad will remove material at a higher removal rate. However, there is a trade-off. In the past, ECMP could remove copper at a high rate, but the surface finish needed improvement.

It would be beneficial to have the high removal rates of ECMP together with the good planarization and smoother surface finishes associated with conventional CMP. The current invention seeks to overcome the prior art deficiencies and provide a process that has high removal rates, good planarization, as well as smooth surface finishes, all while providing a lower down force between the wafer and the polishing pad.

### SUMMARY OF THE INVENTION

The present invention generally concerns a method for electrochemical mechanical processing (ECMP). In this invention, the material removal rate and surface finish are controlled by changing the voltage applied to the wafer, the perforation density of the fully-conductive polishing pad, the down force pressure between the substrate and the polishing pad, and the rotation speed of both the head and the platen. By controlling the current density applied to the wafer through the pad, the perforation density for the pad, the down force pressure, and the rotation speed of both the platen and the head, surface finish and planarization for ECMP rivals that achieved through CMP. In fact, through the instant invention, ECMP achieves a surface finish and planarization rivaling CMP, but at a higher rate than CMP.

A first preferred embodiment of the invention descries a method for electrochemical mechanical polishing comprising providing a rotatable polishing head with a wafer thereon that has a layer to be polished, providing a rotatable platen with a fully conductive polishing pad, and controlling a polishing rate and surface finish of the layer on the wafer. A current is applied to the polishing pad. The polishing pad has a predetermined plurality of perforations. The polishing rate and surface finish are controlled by controlling the surface speed of both the polishing head and platen, controlling the down force pressure between the wafer and the polishing pad, and controlling the current density on the wafer.

A second preferred embodiment of the invention describes a method for electrochemical mechanical polishing of copper. The method involves providing a wafer on a rotatable polishing head, providing a fully conductive polishing pad on a rotatable platen, applying a current to the polishing pad that provides a current density on the wafer, rotating the platen at a speed of 5-60 rpm, rotating the head at a speed of 5-60 rpm, and contacting the wafer with the pad during rotation to remove copper at a rate of 10,000 Å/min or more and resulting in a smooth copper surface. The platen has a diameter of about 28 to about 30 inches. The wafer has a copper layer on the surface and a 300 mm diameter. The polishing pad has a plurality of perforations displacing about 55% of the pad surface and contains imbedded conductive materials. The resulting polished surface has a planarization efficiency of about 1. The current density is about 3.96×10⁻⁴ A/mm².

A third preferred embodiment of the invention describes a method for electrochemical mechanical polishing. The method involves providing a 300 mm wafer that has a layer to be polished on a rotatable polishing head, providing a fully conductive polishing pad that is conductive throughout the entire pad on a rotatable platen, applying a current to the polishing pad to establish a current density on the wafer, rotating the polishing head, rotating the platen, contacting the wafer with the polishing pad and controlling the polishing rate. The polishing rate is controlled by controlling the rotation speed of the head, controlling the rotation speed of the platen, controlling the down force pressure between the wafer and the polishing pad, and controlling the current density on the wafer. The polishing pad has a predetermined density of perforations through the pad.

### DETAILED DESCRIPTION

The present invention involves ECMP using a fully conductive pad having conductive materials. By applying a current to the wafer, a higher material removal rate than CMP can be obtained. Because of the instant invention, good planarization and a smooth surface finish can now be achieved with ECMP that is comparable to or better than that achieved through conventional CMP. In fact, using ECMP as compared to conventional CMP, the surface roughness is comparable. In particular, by controlling the current applied to the wafer, controlling the rotation speed of both the platen and the head, controlling the down force pressure between the wafer and the polishing pad, and controlling the perforation density across the pad, a copper removal rate of 10,000 Å/min and greater is possible. Wafers as large as 300 mm have been processed. A surface roughness as small as 1 nm has been achieved.

Examples of polishing pad assemblies that may be used to practice the invention are described in U.S. patent application Ser. No. 10/455,941, filed Jun. 6, 2003, entitled “Conductive Planarizing Article For Electrochemical Mechanical Planarizing”, and U.S. patent application Ser. No. 10/455,895, filed Jun. 6, 2003, entitled “Conductive Planarizing Article For Electrochemical Mechanical Planarizing,” both of which are hereby incorporated by reference in their entireties. The polishing pad may include embedded conductive materials. Tin is a preferred material for the embedded conductive materials. The platen may be about 28-30 inches in diameter.

When using a fully conductive polishing pad, a very good surface finish across the entire wafer is achieved. For a wafer that was polished at a rate of 9,000 Å/min, the surface finish at the center of the wafer, middle of the wafer, and edge of the wafer was nearly identical. A fully conductive polishing pad evenly distributes the power to the pad and, during processing, to the wafer. The uniform power distribution allows the polishing to occur closer to uniform than would otherwise occur when using the polishing pad of the prior art.

As the surface speed of the platen and the head is increased, the surface finish across the wafer gets smoother. For a given diameter, the higher the rotation speed, the smoother the finish. With a low surface speed, the surface finish has noticeable imperfections. At a low surface speed, the wafer will have an unacceptable surface roughness. However, when the surface speed is increased, the surface finish is much smoother. Generally, for a given diameter, the higher the surface speed of the polishing head and the platen, the smoother the polished surface will be. The platen surface speed will generally be limited because the polishing liquid could spin off. Any surface speed for the platen that would maintain polishing slurry on the pad will be sufficient. Rotation speeds in the range of about 5 to about 100 RPM have proven effective for the platen. On the other hand, rotation speeds in the range of about 5 to about 80 RPM have proven effective for the head. Rotational speeds of 5-60 RPM for both the polishing head and the platen are preferred and will achieve good removal rates and smooth surfaces. The greater the surface speed is, the lower the surface roughness will be.

When the current to the wafer is increased, the surface finish is smoother. When a 300 mm wafer is polished at a current of 15 A with a material removal rate of about 5,000 Å/min, at both the edge and the center of the wafer some surface roughness is observed. When the current is increased to 28 A, the material removal rate increases to about 9,000 Å/min, the surface finish for the wafer is dramatically better than that achieved at a lower current. As an added benefit, increasing the current to the wafer not only smoothes the surface better, it also increases the material removal rate. Generally, the higher the current applied (Hence, the higher the current density), the higher the polishing rate and the smoother the surface will be.

For copper removal, increasing the current will usually increase the copper removal rate. Currents of from about 1.6 A to about 30 A have proven effective to remove copper. Specifically, current densities of about 2.26×10⁻⁵ to about 4.24×10⁻⁴ A/mm² have proven effective to remove copper at a rate of about 1 μm per minute. Preferably, the current density is about 5.66×10⁻⁵ to about 4.24×10⁻⁴ A/mm². It is expected that for a current density of about 8.49×10⁻⁴ A/mm², copper can be removed at a rate of about 2 μm/min.

The perforations in the fully conductive polishing pad allow the polishing slurry to be distributed across the wafer. If there are not enough perforations then there will not enough slurry reaching the wafer. If there is not enough slurry reaching the wafer, then the polishing will be uneven. Conversely, too high a percentage of perforations in the polishing pad will cause mechanical failure of the polishing pad. While the perforation density of the pad generally does not affect the planarization efficiency, the perforation density should not exceed 70%. When the perforation density exceeds 70%, the mechanical strength of the pad is compromised. As the perforation density increases, so does the material removal rate. For example, for a perforation density of 24% in a 28 inch platen, copper can be removed from a 300 mm wafer at about 4250 Å/min. At the same voltage, copper can be removed at a rate of about 9250 Å/min when the perforation density is 55%.

The greater the perforation density, the higher the net current applied to the wafer through the pad. The difference between the total current applied to the pad and the net current applied to the wafer through the pad is called the leaking current. As the perforation density increases, the leaking current of the pad is generally unchanged and is quite low. However, the net current increases with an increasing perforation density. The net current for a 55% perforation density is about 2 times that of the 24% perforation density pad. Therefore, as the perforation density increased, so is the net current applied to the wafer through the pad.

By controlling the current applied to the wafer through a fully conductive polishing pad, by changing the percent of perforations present on the fully conductive polishing pad, by controlling the down force pressure applied between the wafer and the polishing pad, and by controlling the rotation speed of both the polishing head and the platen, ECMP can be more effective than CMP. The removal rate, the planarization efficiency, down force pressure, and the surface finish smoothness using ECMP can be controlled wafer-to-wafer or within a single wafer. Planarization efficiency is the efficiency of removing material from the surface of the wafer to result in a smooth, planar wafer surface. Prior to polishing, the wafer surface will be rough with numerous steps and valleys on the surface. The planarization efficiency is obtained by dividing the amount from which the step height is reduced from the wafer by the amount of material removed from the wafer.

The percentage of perforations on the polishing pad has virtually no effect on the planarization efficiency. As material is removed from the surface of the wafer during polishing, the planarization efficiency approaches 1.0 across the entire wafer. A planarization efficiency of close to 1.0 can be achieved for all polishing regions and at all polishing rates using the present invention.

TABLE 1

| | | Net | | Material |
|---|---|---|---|---|
| | | current | Current | removal |
| | Perforation | applied | density | rate |
| Example | density % | (A) | (A/mm²) | (kÅ/min) |
| 1 | 55 | 6 | 8.49e−5 | 2 |
| 2 | 55 | 12 | 1.7e−4 | 4 |
| 3 | 55 | 15 | 2.12e−4 | 5 |
| 4 | 55 | 19 | 2.69e−4 | 6.3 |
| 5 | 55 | 23.5 | 3.2e−4 | 7.8 |
| 6 | 55 | 28 | 3.96e−4 | 9.3 |
| 7 | 24 | 3 | 4.24e−5 | 1 |
| 8 | 24 | 5 | 7.07e−5 | 1.67 |
| 9 | 24 | 7 | 9.90e−5 | 2.3 |
| 10 | 24 | 9 | 1.27e−4 | 3 |
| 11 | 24 | 11 | 1.56e−4 | 3.67 |
| 12 | 24 | 13 | 1.84e−4 | 4.3 |
| 13 | 24 | 14.5 | 2.05e−4 | 4.83 |
| 14 | 24 | 15.5 | 2.19e−4 | 5.17 |
| 15 | 24 | 17 | 3.4e−4 | 5.67 |

As can be seen from Table 1, as the net current is increased, so is the material removal rate. The material removal rate is also affected by the perforation density. As the perforation density is increased, so is the current density and the material removal rate.

While the foregoing is directed to embodiments of the present invention, other and further embodiments of the invention may be devised without departing from the basic scope thereof, and the scope thereof is determined by the claims that follow.

1. A method for electrochemical mechanical polishing, comprising:
rotating a polishing head with a wafer thereon, the wafer comprising a layer to be polished;
rotating a platen with a fully conductive polishing pad while applying current to the pad, wherein the pad has a surface having a predetermined plurality of perforations; and
controlling a polishing rate and surface finish of the layer on the wafer by controlling the surface speed of both the polishing head and platen, controlling a down force pressure between the wafer and the pad, and controlling a current density on the wafer.

2. The method as claimed in claim 1, wherein the perforations displace about 24% to about 70% of the surface of the polishing pad.

3. The method as claimed in claim 2, wherein the perforations displace about 55% of the surface of the polishing pad.

4. The method as claimed in claim 1, wherein the current density is about 2.26×10⁻⁵ to about 4.24×10⁻⁴ A/mm².

5. The method as claimed in claim 4, wherein the current density is about 5.66×10⁻⁵ to about 4.24×10⁻⁴ A/mm².

6. The method as claimed in claim 1, wherein the platen is rotated at a rate of about 5-100 rpm and the platen has a diameter of about 28 inches to about 30 inches.

7. The method as claimed in claim 6, wherein the platen is rotated at a rate of about 5-60 rpm.

8. The method as claimed in claim 1, wherein the wafer comprises a copper layer.

9. The method as claimed in claim 1, further comprising removing material at a rate of about 5,000 Å/min to about 10,000 Å/min.

10. The method as claimed in claim 9 wherein the rate is about 9,000 Å/min.

11. The method as claimed in claim 1, further comprising removing material at a rate of greater than 10,000 Å/min.

12. The method as claimed in claim 1, further comprising polishing the wafer until all regions of the wafer are equally planarized.

13. The method as claimed in claim 1, further comprising removing material at a rate of about 5,000 Å/min and applying a current density of about 2.69×10⁻⁴ A/mm².

14. The method as claimed in claim 1, further comprising removing material at a rate of about 9,000 Å/min and applying a current density of about 3.96×10⁻⁴ A/mm².

15. The method as claimed in claim 1, wherein the pad comprises imbedded conductive materials.

16. A method for electrochemical mechanical polishing of a copper layer, comprising:
rotating a wafer on a rotatable polishing head at a speed of 5-60 rpm, the wafer comprising a copper layer;
rotating a fully conductive polishing pad on a rotatable platen at a speed of 5-60 rpm, the pad having a plurality of perforations and the pad comprising imbedded conductive materials;
applying a current to the pad, wherein the current provides a current to the wafer; and
contacting the wafer with the pad during rotation to polish the copper layer and remove copper at a rate of about 10,000 Å/min or more using a current density of about 3.96×10⁻⁴ A/mm².

17. A method for electrochemical mechanical polishing, comprising:
rotating a wafer that comprises a layer to be polished on a rotatable polishing head;
rotating a fully conductive polishing pad on a rotatable platen, the pad having a predetermined density of perforations through the pad;
applying a current to the pad to establish a current density on the wafer;
contacting the wafer with the pad; and
controlling the polishing rate by controlling the rotation speed of the head, controlling the rotation speed of the platen, controlling the down force pressure between the wafer and the pad, and controlling the current density on the wafer.

18. The method as claimed in claim 17, wherein the predetermined density of perforations is from about 24% to about 55%.

19. The method as claimed in claim 17, wherein the wafer comprises a copper layer.

20. The method as claimed in claim 17, wherein the polishing head rotates faster than the platen.
